(19) United States
(12) Patent Application Publication
(10) Pub. No.: US 2024/0064440 A1
(43) Pub. Date: Feb. 22, 2024

(54) COMMUNICATION SYSTEM, COMMUNICATION DEVICE, COMMUNICATION METHOD, AND RECORDING MEDIUM

(71) Applicant: M.D.B Corporation, Tokyo (JP)

(72) Inventor: Kei Shinmi, Tokyo (JP)

(73) Assignee: M.D.B Corporation, Tokyo (JP)

(21) Appl. No.: 18/269,024

(22) PCT Filed: Mar. 23, 2021
(86) PCT No.: PCT/JP2021/011911

§ 371 Date: Jun. 22, 2023

(51) Int. Cl. H04Q 9/00

(52) U.S. Cl. CPC H04Q 9/00

(57) ABSTRACT

The wireless communication terminal transmits acquired data by wireless communication. The gateway device receives the data from the wireless communication terminal. The polling device performs polling to the gateway device to control data reception of the gateway device from the wireless communication terminal. Also, the pooling device receives the data that the gateway device received from the wireless communication terminal from the gateway device. The server device controls activation and stop of the polling device. The server device receives the data that the polling device received from the gateway device.

### TECHNICAL FIELD

The present invention relates to a technique for collecting information measured by a sensor or the like.

### BACKGROUND ART

There is a need that pet owners want to grasp the state and behavior of the pets in their homes during their work or when they are going out. Patent Document 1 describes a system which detects a state of a pet by a sensor terminal, generates utterance data of a first person on the basis of the detected data, and performs conversation with the owner or other user by an interactive SNS. Also, Patent Document 2 discloses a gateway device which communicates with a wireless communication terminal and an equipment using IP (Internet Protocol).

### PRECEDING TECHNICAL REFERENCES

### Patent Document

Patent Document 1: International Publication WO2016/125478
Patent Document 2: Japanese Patent Application Laid-open under No. 2014-22808

### SUMMARY

### Problem to be Solved

Recently, there are known sensors which can transmit measurement data by radio communication such as BLE (Bluetooth Low Energy). When such a sensor is used for detecting the state of a pet, it is desired to acquire the measured data without delay in a manner close to the real time basis.

One object of the present invention is to collect data from devices capable of wireless communication with as small delay as possible.

### Means for Solving the Problem

In order to solve the above problem, according to an example aspect of the present disclosure, there is provided a communication system comprising:
a wireless communication terminal configured to transmit acquired data by wireless communication;
a gateway device configured to receive the data from the wireless communication terminal;
a polling device configured to perform polling to the gateway device to control data reception of the gateway device from the wireless communication terminal, and receive the data that the gateway device received from the wireless communication terminal from the gateway device; and
a server device configured to control activation and stop of the polling device, and receive the data that the polling device received from the gateway device.

According to another example aspect of the present disclosure, there is provided a communication device comprising:
a polling means configured to perform polling to a gateway device that receives data from a wireless communication terminal to control data reception of the gateway device from the wireless communication terminal, and receive the data that the gateway device received from the wireless communication terminal from the gateway device; and
a receiving means configured to receive the data that the polling means received from the gateway device.

According to still another example aspect of the present disclosure, there is provided a communication method comprising:
performing polling to a gateway device that receives data from a wireless communication terminal to control data reception of the gateway device from the wireless communication terminal;
receiving the data that the gateway device received from the wireless communication terminal from the gateway device; and
receiving the data that the polling means received from the gateway device.

According to still another example aspect of the present disclosure, there is provided a recording medium recording a program, the program causing a computer to execute processing of:
performing polling to a gateway device that receives data from a wireless communication terminal to control data reception of the gateway device from the wireless communication terminal;
receiving the data that the gateway device received from the wireless communication terminal from the gateway device; and
receiving the data that the polling means received from the gateway device.

Effect

According to the present disclosure, it is possible to collect data from devices capable of wireless communication with as small delay as possible.

### BRIEF DESCRIPTION OF THE DRAWINGS

FIG. 1 shows an overall configuration of a system.

FIG. 2 shows a configuration for transmitting data from a pet terminal to a server.

FIG. 3 shows a flow of processing for transmitting data from the pet terminal to the server.

FIG. 4 is a block diagram showing a configuration of a home system.

FIG. 5 is a block diagram showing a configuration of a pet terminal.

FIGS. 6A and 6B are block diagrams showing configurations of a polling device and a server.

FIG. 7 is a block diagram showing a configuration of a user terminal.

FIG. 8 shows an example of determining a state of a pet when a vibration count is used as a physical quantity.

FIG. 9 shows examples of message information corresponding to a state or a state change of a pet.

FIG. 10 shows an example of displaying message information by the user terminal.

FIG. 11 is a block diagram showing a functional configuration of a communication system of a second example embodiment.

FIG. 12 is a block diagram showing a functional configuration of a communication device of a third example embodiment.

FIG. 13 is a flowchart of processing by the communication device of the third example embodiment.

### EXAMPLE EMBODIMENTS

### First Example Embodiment

[Overall Configuration]

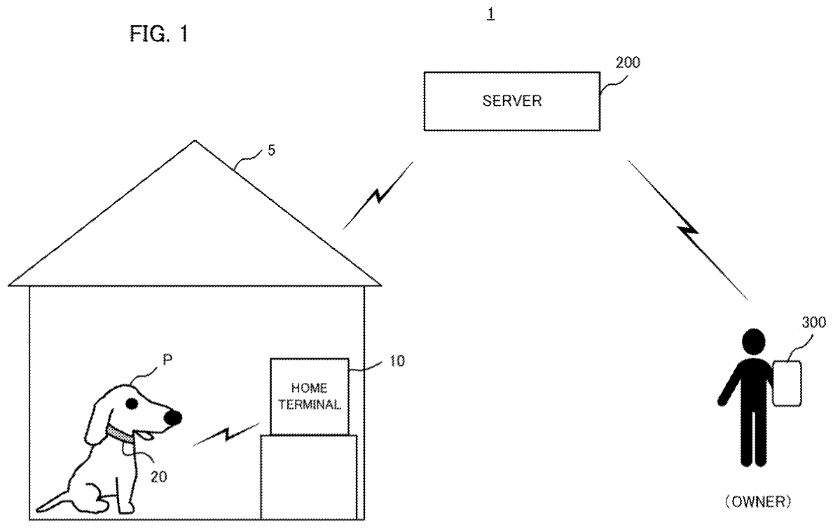

FIG. 1 shows an overall configuration of a communication system according to the present disclosure. The communication system 1 includes a home terminal 10 installed in a home 5 of an owner of a pet, a server 200, and a user terminal 300 used by the owner. The pet P is staying at the home 5 of the owner, and a pet terminal 20 is attached to the pet P. The home terminal 10 and the server 200 can communicate by wired or wireless communication. The server 200 can also communicate wirelessly with the user terminal 300 of the owner.

As a basic operation, the home terminal 10 transmits data related to a state of the pet P (hereinafter referred to as “pet data”) acquired by the pet terminal 20 to the server 200. The server 200 determines the behavior, state or the like (hereinafter referred to as “state”) of the pet P based on the received data, generates message information about the pet P based on the determined state, and transmits the message information to the user terminal 300 of the owner via an interactive SNS (Social Network Service). Here, the message information includes a text message, a stamp, an image and the like.

Specifically, when the transmission timing arrives, the server 200 transmits the message information expressing the state of the pet P at that time to the user terminal 300 of the owner via the interactive SNS. The owner can know the state of the pet P by viewing the message information transmitted to the user terminal 300.

The message information generated may be based on the behavior, the location, and the state of the pet P. The transmission timing of the message information may be arbitrary set. For example, the message information may be transmitted initially from the pet side when the state of the pet changes. Also, the message information may be transmitted based on the request of the owner. It is also possible to perform interactive conversation such that the owner transmits the image or message to the pet P and the pet P returns the image or message or stamp to the owner. For example, when the owner transmits the message “Did you have a meal?”, the pet P may return the image of the rice and the stamp. Further, the pet P may transmit the message information with a predetermined time interval.

[Transmitting Pet Data]

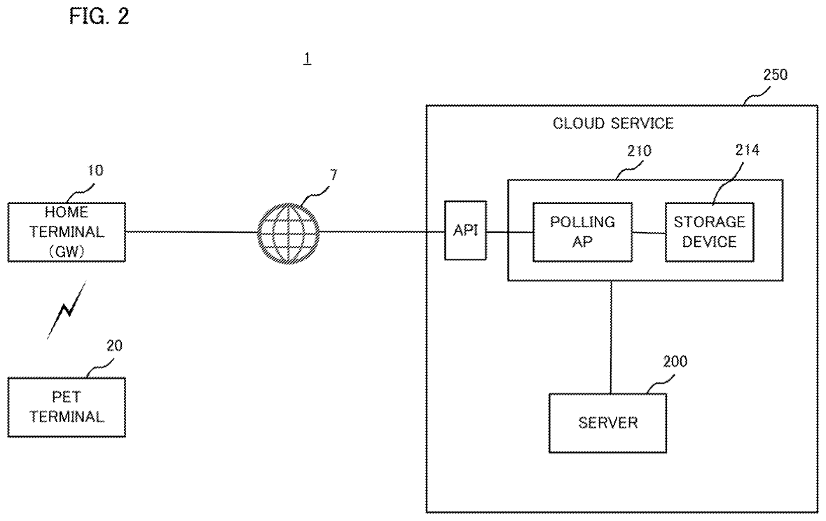

FIG. 2 shows a configuration for transmitting the pet data generated by the pet terminal 20 to the server 200. The pet terminal 20 is a sensor or the like that uses BLE communication and communicates with the home terminal 10 by Bluetooth (registered trademark). The home terminal 10 is a gateway (GW) device that mediates the BLE communication with the pet terminal 20 and the IP communication connecting to the Internet 7 through WiFi (wireless LAN). The home terminal 10 is connected to the cloud service 250 through the Internet 7. Incidentally, the pet terminal 20 is an example of a wireless communication terminal, and the home terminal 10 is an example of a gateway device.

The server 200 is implemented on the cloud service 250. Further, a polling device 210 for acquiring the pet data from the home terminal 10 is provided on the cloud service 250. The polling device 210 transmits and receives data to and from the home terminal 10 via an API (Application Programming Interface) for receiving data. The polling device 210 operates by executing a polling application (hereinafter referred to as “polling AP”). The polling device 210 may be configured as a server on the cloud service 250. The polling AP is an example of a polling means.

The pet terminal 20 and the home terminal 10 perform the BLE communication. Specifically, the pet terminal 20 corresponds to a peripheral device in the BLE communication, and the home terminal 10 corresponds to a central device in the BLE communication. The pet terminal 20 periodically transmits the advertising. The pet terminal 20 according to the present example embodiment transmits the advertising even when various sensors acquire the data related to the activity of the pet P. When the home terminal 10 searches (scans) the pet terminal 20 existing in the vicinity and receives the advertising from the pet terminal 20, the home terminal 10 establishes a connection with the pet terminal 20 and receives the pet data from the pet terminal 20. Thus, when the timing of the advertising from the pet terminal 20 matches the timing of the search by the home terminal 10, the pet data can be transmitted from the pet terminal 20 to the home terminal 10. Incidentally, when the pet terminal 20 cannot transmit the pet data to the home terminal 10, the pet terminal 20 stores the pet data in the internal memory or the like and transmits the pet data stored in the internal memory when the pet terminal 20 is connected to the home terminal 10.

Since the server 200 transmits the message information to the user terminal 300 of the owner according to the state of the pet P, it is necessary to acquire the pet data from the pet terminal 20 in a manner as close to the real time basis as possible. The polling device 210 is provided for this purpose. The polling AP operating at the polling device 210 requests the home terminal 10 to search for the pet terminal 20 serving as a BLE device by polling. The home terminal 10 searches the pet terminal 20 at the polling interval (frequency) instructed by the polling AP. The polling interval by the polling AP is tuned to match the timing of the advertising of the pet terminal 20. That is, the polling interval by the polling AP is adjusted so that the timing of the advertising by the pet terminal 20 is more consistent with the timing of searching the BLE device by the home terminal 10. Thus, the chance that the home terminal 10 can acquire the pet data from the pet terminal 20 is increased, and it is possible to acquire the pet data in a manner close to the real time basis without delay. Incidentally, by tuning the polling interval to suit a plurality of BLE devices, it is possible to use a plurality of BLE devices together. The home terminal 10 transmits the pet data received from the pet terminal 20 to the polling AP.

The polling AP executes necessary format conversion of the received pet data according to the interface on the server 200, and transmits the data to the server 200. In this way, the server 200 acquires the pet data measured by the sensors of the pet terminal 20. The timing at which the polling AP transmits the pet data to the server 200 is set to the polling AP. Since the polling AP autonomously transmits the pet data to the server 200 at the set timing, it is not necessary for the server 200 to send the request of the pet data to the polling AP. By setting the interval of transmitting the pet data to the server 200 short, it becomes possible to acquire the pet data in a manner close to the real time basis.

The polling AP may be provided with a function for storing the pet data received from the home terminal 10. In this case, a storage device 214 such as a memory is provided in the polling device 210. The polling AP temporarily stores the pet data received from the home terminal 10 in the storage device 214, and transmits the data to the server 200 in the order from the old data to the new data at the transmission timing set to the polling AP itself. Thus, the pet data measured by the pet terminal 20 can be fully transmitted to the server 200. Further, by providing a function of accumulating the pet data in the polling device 210, it is possible to reduce the burden of accumulating the pet data that could not transmitted on the pet terminal 20 side. Therefore, it is possible to prevent the sensing ability of the sensors of the pet terminal 20 from being deteriorated due to the load of storing the pet data. Note that it is not mandatory to provide a function to accumulate the pet data in the polling AP.

In a case where the storage function of the pet data is provided, the polling AP may select only a portion of the pet data stored in the storage device 214 and transmit it to the server 200. Specifically, the polling AP may transmit only the new data of the pet data stored in the storage device 214 to the server 200. Since the server 200 generates the message information based on the pet data received from the polling AP and transmits the message information to the user terminal 300 of the owner, it is preferable that the polling AP transmits the new data to the server 200 as much as possible when the polling AP can acquire the new data. From this point of view, the polling AP may discard the old data of the accumulated pet data that has elapsed a certain period of time, and transmit only the new data to the server 200.

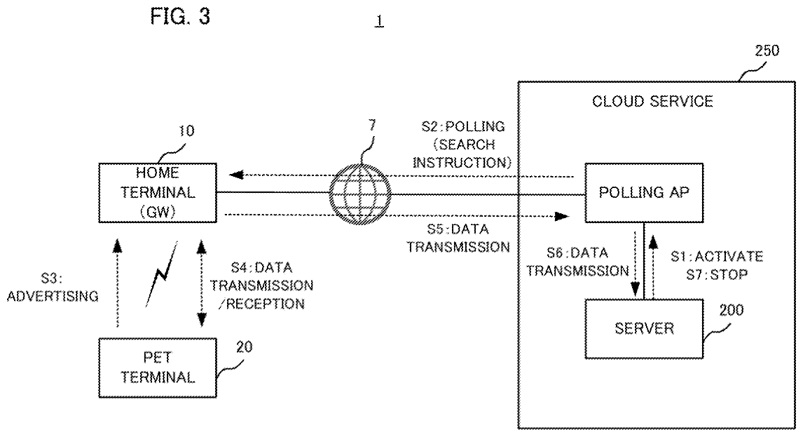

FIG. 3 shows a flow of processing of transmitting the pet data acquired by the pet terminal 20 to the server 200. First, the server 200 sends an instruction of activation to the polling AP (step S1). When activated by the instruction from the server 200, the polling AP sends the search instruction to the home terminal 10 at the polling interval set to itself (step S2).

On the other hand, the pet terminal 20 transmits the advertising at its own timing (step S3). When the timing of the advertising by the pet terminal 20 matches the timing of the search by the home terminal 10, the home terminal 10 acquires the pet data from the pet terminal 20 (step S4) and transmits the pet data to the polling AP (step S5).

The polling AP transmits the pet data received from the home terminal 10 to the server 200 (step S6). At this time, the polling AP performs necessary data format conversion and the like. Incidentally, in a case where the polling AP has a storage function of the pet data as described above, the polling AP may transmit the the received pet data to the server 200 after temporarily storing it in the storage device 214, or may discard the old data and transmit only the new data.

Thus, the above processes are continued until the stop instruction is transmitted from the server 200 to the polling AP. When the stop instruction is transmitted (step S7), the processing ends.

(Modification)

Although the polling function by the polling AP is provided in the cloud service 250 in the communication system 1 described above, the polling function by the polling AP may be provided in the home terminal 10 instead.

Although the pet data acquired from the pet terminal 20 is transmitted to the server 200 in the above example, this disclosure is not limited to this example. The configuration of FIG. 2 can be used to transmit other various data.

[Home Terminal]

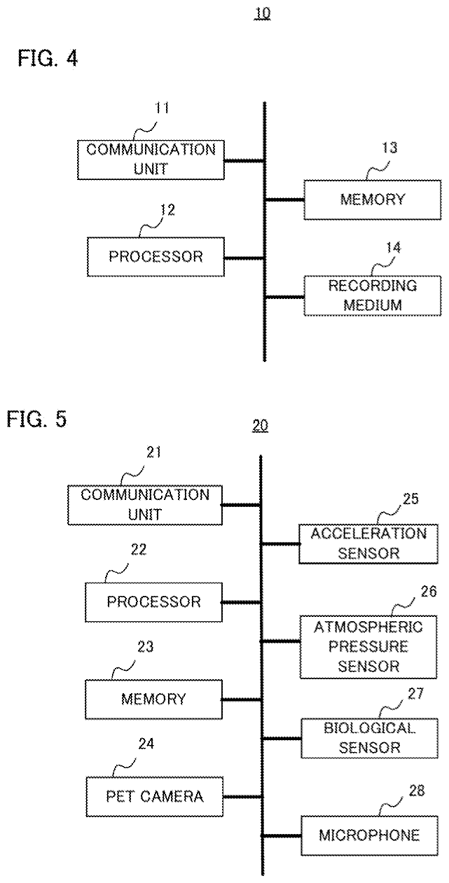

FIG. 4 is a block diagram showing a configuration of the home terminal 10. The home terminal 10 functions as a gateway device between the aforementioned BLE communication and IP communication, and includes a communication unit 11, a processor 12, a memory 13, and a recording medium 14.

The communication unit 11 wirelessly communicates with the pet terminal attached to the pet P by the BLE communication. The communication unit 11 communicates with the polling device 210 by the IP communication.

The processor 12 is a computer such as a CPU (Central Processing Unit) and controls the entire home terminal 10 by executing a program prepared in advance. The processor 12 may be a GPU (Graphics Processing Unit), a FPGA (Field-Programmable Gate Array), a DSP (Demand-Side Platform), an ASIC (Application Specific Integrated Circuit), or the like. The processor 12 executes the aforementioned gateway function by executing a program prepared in advance.

The memory 13 may be a ROM (Read Only Memory) and a RAM (Random Access Memory). The memory 13 stores various programs executed by the processor 12. The memory 13 is also used as a working memory during various processes executed by the processor 12.

The recording medium 14 is a non-volatile and non-transitory recording medium such as a disk-like recording medium and a semiconductor memory, and is configured to be detachable from the home terminal 10. The recording medium 14 records various programs executed by the processor 12.

[Pet Terminal]

FIG. 5 is a block diagram showing a configuration of the pet terminal 20 attached to the pet P. The pet terminal 20 may be attached to the pet instead of the collar of the pet P or attached to the collar that the pet is wearing, for example. The pet terminal 20 is a BLE device, and includes a communication unit 21, a processor 22, a memory 23, a pet camera 24, an acceleration sensor 25, an atmospheric pressure sensor 26, a biological sensor 27, and a microphone 28.

The communication unit 21 communicates wirelessly with the home terminal 10 through the BLE communication. The processor 22 is a computer, such as a CPU, that controls the entire pet terminal 20 by executing a predetermined program. The processor 22 transmits the information acquired by the sensors and the microphone to the home terminal 10 by executing a program prepared in advance. Specifically, the processor 22 transmits the advertising periodically and when the sensors detect an activity of a predetermined amount or more of the pet P. The processor 22 transmits the pet data acquired from the sensors to the home terminal when communication with the home terminal 10 is established.

The memory 23 is configured by a ROM, RAM or the like. The memory 23 stores various programs executed by the processor 22. The memory 23 is also used as a working memory during various processes executed by the processor 22. Furthermore, the memory 23 temporarily stores the pet data detected by the sensors before transmitting it.

The pet camera 24 is a camera for shooting the image of the pet′ view. The pet camera 24 may be configured to detect the orientation of the neck of the pet P to determine the shooting direction, may be mounted near the head of the pet P, or may be a camera that shoots the front of the pet P at a wide angle. Thus, the home terminal 10 can acquire the images of the pet's view.

The acceleration sensor 25 is a three-axis acceleration sensor, and measures the motion of the pet P in the three-axis direction. Specifically, the acceleration sensor 25 can output the movement amount or a vibration count of the pet P. Based on the output of the acceleration sensor 25, the server 200 can estimate the activity amount of the pet P or the like. The atmospheric pressure sensor 26 measures the atmospheric pressure at the place of the pet P. Based on the output of the atmospheric pressure sensor 26, the server 200 can detect the number of times, the distance and the accumulated distance of the vertical movement of the pet P, e.g., a jump. Further, although not shown in FIG. 5, a gyro sensor may be used. A six-axis sensor in which a three-axis acceleration sensor and a three-axis gyro sensor (a three-axis angular velocity sensor) are integrated may be used. The sensor is not limited to the above-described one as long as the sensor can measure the activity amount of the animal.

The biological sensor 27 is a sensor for measuring the biological information of the pet P. For example, the biological sensor 27 measures the body temperature, the heart rate and the respiration rate of the pet P. The microphone 28 collects the sound around the pet P. The server 200 can estimate the state of the pet P such as yelping or barking, based on the received sound. The server 200 can estimate the motion state, the mental state, or the like of the pet based on the sound of the pet P running around or the breath sound, for example.

[Polling Device]

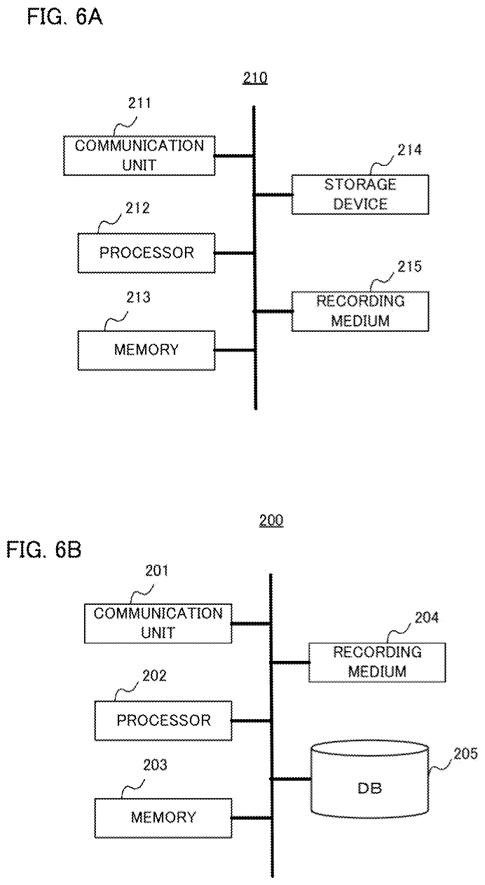

FIG. 6A is a block diagram showing a configuration of the polling device 210. The polling device 210 receives the pet data from the home terminal 10 and transmits it to the server 200. The polling device 210 includes a communication unit 211, a processor 212, a memory 213, a storage device 214, and a recording medium 215.

The communication unit 211 communicates with the home terminal 10 and the server 200. The processor 212 is a computer, such as a CPU, that controls the entire polling device 210 by executing programs prepared in advance. The processor 212 may be a GPU, FPGA, DSP, ASIC or the like. Specifically, the processor 212 transmits the search instruction to the home terminal 10 through the communication unit 211 by polling, and receives the pet data from the home terminal 10. The processor 212 transmits the pet data received from the home terminal 10 to the server 200 through the communication unit 211.

The memory 213 is configured by a ROM, RAM. The memory 213 is also used as a working memory during various processing operations by the processor 212. The storage device 214 is a recording medium such as a semiconductor memory, and stores the pet data received from the home terminal 10.

The recording medium 215 is a non-volatile and non-transitory recording medium such as a disk-like recording medium or a semiconductor memory, and is configured to be detachable from the polling device 210. The recording medium 215 records programs executed by the processor 212. The polling AP is stored in the recording medium 215.

[Server]

FIG. 6B is a block diagram illustrating a configuration of the server 200. The server 200 transmits messages to and receives messages from the user terminal 300 by the interactive SNS. The server 200 includes a communication unit 201, a processor 202, a memory 203, a recording medium 204, and a database 205.

The communication unit 201 receives the pet data from the home terminal through the polling device 210. The communication unit 201 transmits and receives the message information to and from the user terminal 300 of the owner.

The processor 202 is a computer, such as a CPU, that controls the entire server 200 by executing a program prepared in advance. The processor 202 may be a GPU, a FPGA, a DSP, an ASIC or the like. Specifically, the processor 202 determines the state of the pet P based on the pet data, and transmits the message information to the user terminal 300 of the owner by the interactive SNS.

The memory 203 is configured by a ROM, RAM, or the like. The memory 203 is also used as a working memory during various processes executed by the processor 202. The recording medium 204 is a non-volatile and non-transitory recording medium such as a disk-like recording medium or a semiconductor memory and is configured to be detachable from the server 200. The recording medium 204 records various programs executed by the processor 202.

The database 205 stores information and images received from the home terminal 10 through the communication unit 201. The message information transmitted by the users from the user terminals 300 are stored in the database 205. Further, the database 205 stores, for each user, the transmission timing of the message information, and the message information prepared in advance (e.g., a predetermined message, stamp, etc.). The server 200 may include an input unit such as a keyboard and a mouse to allow an administrator to give instructions or input, and a display unit such as a liquid crystal display.

[User Terminal]

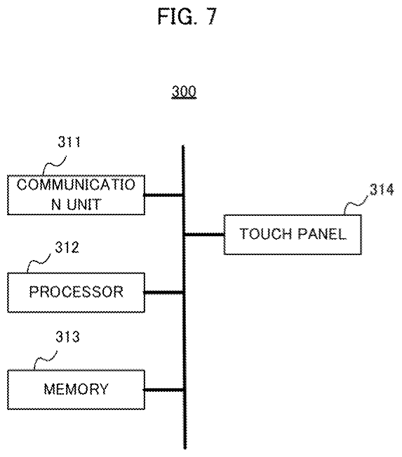

FIG. 7 is a block diagram illustrating a configuration of the user terminal 300 used by the owner. The user terminal 300 is, for example, a smartphone, a tablet, a PC, or the like. The user terminal 300 includes a communication unit 311, a processor 312, a memory 313, and a touch panel 314.

The communication unit 311 transmits and receives data to and from the external device. Specifically, the communication unit 311 transmits and receives information to and from the server 200.

The processor 312 is a computer, such as a CPU, and controls the entire user terminal 300 by executing a program prepared in advance. The processor 312 may be a GPU, a FPGA, a DSP, an ASIC or the like. Specifically, the user terminal 300 is installed with a messaging application for the interactive SNS executed by the server 200. The “messaging application” is an application that provide exchange of information such as text messages, stamps, still images and videos. The processor 312 receives the message information from the server 200 by the messaging application and displays the message information on the touch panel 314. The processor 312 also transmits message information inputted by the owner to the server 200 through the messaging application.

The memory 313 is configured by a ROM and a RAM. The memory 313 stores the messaging application. The memory 313 is also used as a working memory during various processing by the processor 312. The touch panel 314 displays the message information received by the user terminal 300. The touch panel 314 also functions as an input device of a user.

[Transmission of Message Information]

Next, transmitting the message information to the user terminal 300 of the owner will be described. The server 200 transmits the message information of appropriate contents to the user terminal 300 of the owner based on the state of the pet P. More specifically, the server 200 determines the state of the pet P based on the size of the physical quantity related to the movement or behavior of the pet P, and transmits the message information corresponding to the determined state to the user terminal 300 of the owner.

(Determination of Pet State)

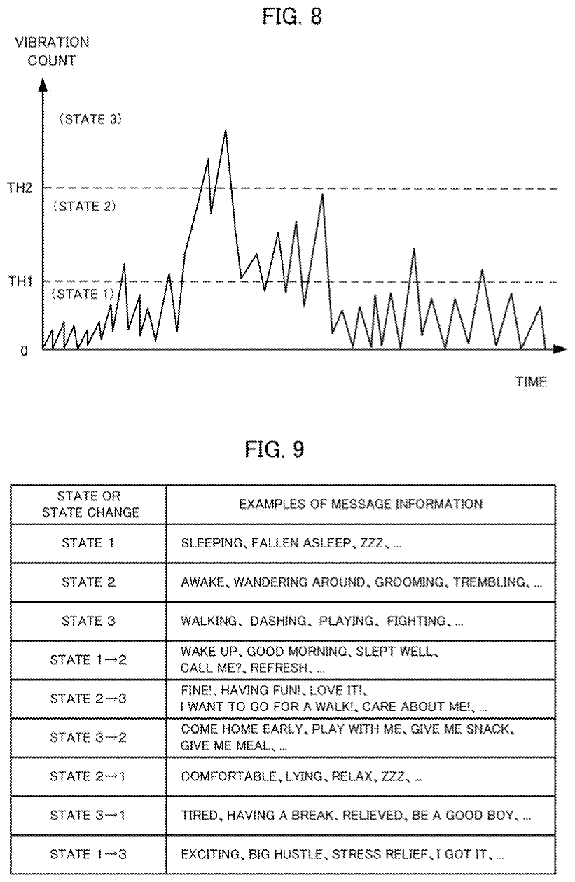

The server 200 acquires the physical quantity regarding the movement or the behavior of the pet P as the pet data and determines the state of the pet P. FIG. 8 shows an example of determining the state of the pet when a vibration count acquired from the pet terminal 20 is used as the physical quantity. The vibration count is only an example of a physical quantity indicating the state of the pet P, and is not limited thereto.

FIG. 8 shows a graph of the vibration count of the pet P measured by the pet terminal 20. In this example, the server 200 classifies the state of the pet P into the states 1 to 3 based on the vibration count. Note that this classification is merely an example, and the method of classifying the state of the pet P is not limited to this example. The state 1 is the case where the vibration count is smaller than the threshold TH1, and the pet P is sleeping. The state 2 is the case where the vibration count is equal to or larger than the threshold TH1 and is smaller than the threshold TH2, and the pet P is performing a short movement or a small movement (hereinafter, referred to as a “small movement state”). The state 3 is the case where the vibration count is equal to or larger than the threshold TH2, and the pet P is performing a long movement or a large movement (hereinafter, referred to as “large movement state”). As shown in FIG. 8, the state of the pet P changes from moment to moment based on the change in the vibration count.

The server 200 determines the message information to be transmitted to the owner according to the state of the pet P. The server 200 may determine the message information according to the time change of the state of the pet P. FIG. 9 shows examples of the message information prepared in connection with the state or the state change of the pet P. The message information of FIG. 9 are merely examples, and other message information may be used. The server 200 randomly selects one or more message information from a plurality of message information prepared for each state or state change, and transmits the information to the user terminal 300.

If the pet P is in the state 1 (i.e., the sleeping state), the server 200 selects the message information expressing that the pet P is in a sleeping state, such as “sleeping,” “fallen asleep”, for example. If the pet P is in the state 2 (i.e., the small movement state), the server 200 selects the message information expressing that the pet P is awake and doing daily activities, for example, “awake,” “wandering around,” and the like. If the pet P is in the state 3 (i.e., the large movement state), the server 200 selects the message information expressing that the pet P is in an active state, for example, “walking,” “dashing,” and the like. Thus, by using the size of the physical quantity regarding the movement or behavior of the pet P, it is possible to finely determine the state of the pet P including the size (degree) of the movement or behavior.

In addition, when the state of the pet P changes from one of the states 1 to 3 to another, the server 200 selects the message information corresponding to the change. For example, as illustrated in FIG. 9, when the state of the pet P changes from the state 1 (i.e., the sleeping state) to the state 2 (i.e., the small movement state), the server 200 selects the message information such as “wake up”, “Good morning.” When the state of the pet P changes from the state 2 (i.e., the small movement state) to the state 3 (i.e., the large movement state), the server 200 selects the message information such as “Fine!” or “Having fun!”, for example. Similarly, the message information as illustrated in FIG. 9 is selected for the other state changes. Thus, by using the time change of the physical quantity regarding the movement or behavior of the pet P, it is possible to determine the state of the pet P that changes from moment to moment in more detail. While a text message is used as the message information in the example of FIG. 9, a stamp or an image may be used.

While the state of the pet P is classified into three states in the above example, one or more of those states may be further subdivided. For example, state 1 (i.e., the sleeping state) may be subdivided into “Sound sleep,” “Shallow sleep,” “Just lying on the side,” etc. In this case, the server 200 may subdivide the state 1 by subdividing the threshold used for the classification of the states 1 to 3. For example, if the threshold TH1 of the vibration count is “10”, the server 200 may determine that the vibration count “0” to “3” correspond to “Sound sleep”, that the vibration count “4” to “7” correspond to “Shallow sleep”, and the vibration count “8” to “10” correspond to “Just lying on the side”. Alternatively, the server 200 may combine the vibration count with the values of other sensors to determine a subdivided classification. Specifically, the sleeping state may be subdivided based on biological information of the pet P, e.g., the body temperature, the heart rate, the respiration rate, and the like, in addition to the vibration count.

(Example of Transmitting Message Information)

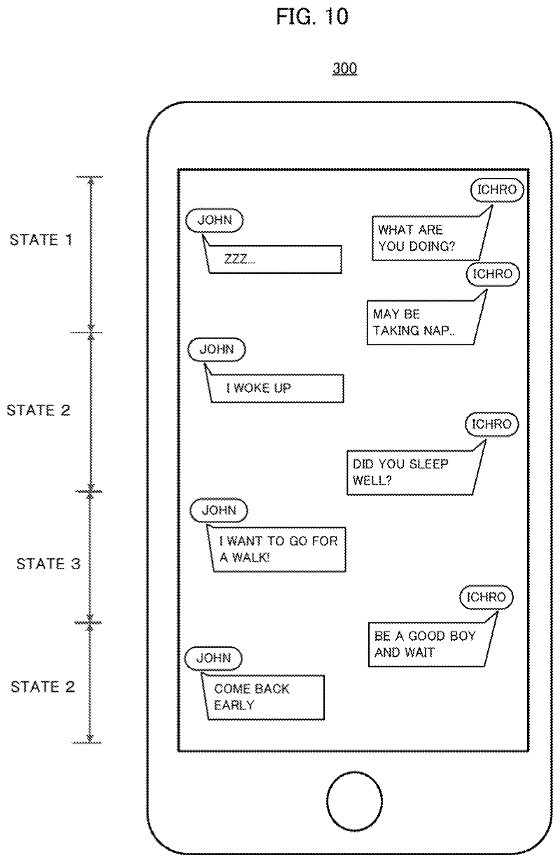

FIG. 10 shows an example of transmitting the message information by the server 200. FIG. 10 is an example of displaying the message information in the user terminal 300 of the owner. Note that the name the owner is “Ichiro” and the name of the pet P is “John”.

First, the owner sent the message “What are you doing?”. At that time, the pet P was in the state 1 (the sleeping state), and the server 200 transmitted the message information “ZZZ . . . ” corresponding to the state 1 to the owner, as shown in FIG. 9. In response, the owner sent the message “Maybe taking nap . . . ”

Thereafter, when the state of the pet P changed from the state 1 to the state 2 (the small movement state), the server 200 transmitted the message information “I woke up!” corresponding to the change from the state 1 to the state 2 as shown in FIG. 9. In response, the owner sent the message “Did you sleep well?”.

Thereafter, when the state of the pet P changed from the state 2 to the state 3 (the large movement state), the server 200 transmitted the message information “I want to go for a walk!” corresponding to the change from the state 2 to the state 3 as shown in FIG. 9. In response, the owner transmitted the message information “Be a good boy and wait”.

Thereafter, when the state of the pet P returned from the state 3 to the state 2, the server 200 transmitted the message information “Come back early” corresponding to the change from the state 3 to the state 2, as shown in FIG. 9.

Thus, by transmitting the message information according to the state or the state change of the pet P, comfortable conversation with the pet P becomes possible.

### Second Example Embodiment

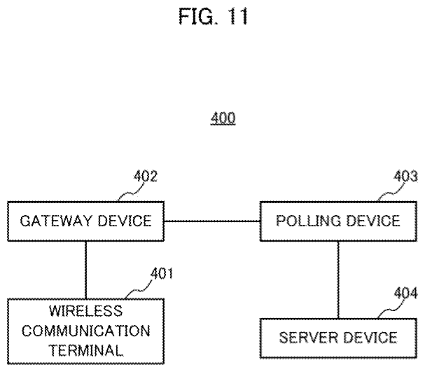

FIG. 11 is a block diagram showing a configuration of a communication system of a second example embodiment. The communication system 400 includes a wireless communication terminal 401, a gateway device 402, a polling device 403, and a server device 404.

The wireless communication device 401 transmits the acquired data by the wireless communication. The gateway device 402 receives data from the wireless communication terminal 401. The polling device 403 performs polling to the gateway device 402 to control the data reception of the gateway device 402 from the wireless communication terminal 401. Also, the polling device 403 receives, from the gateway device 402, the data that the gateway device 402 received from the wireless communication terminal 401. The server device 404 controls the activation and the stop of the polling device 403. The server device 404 receives the data that the polling device 403 received from the gateway device 402. Thus, the server device 404 can collect the data from the wireless communication terminal 401 with the least possible delay.

### Third Example Embodiment

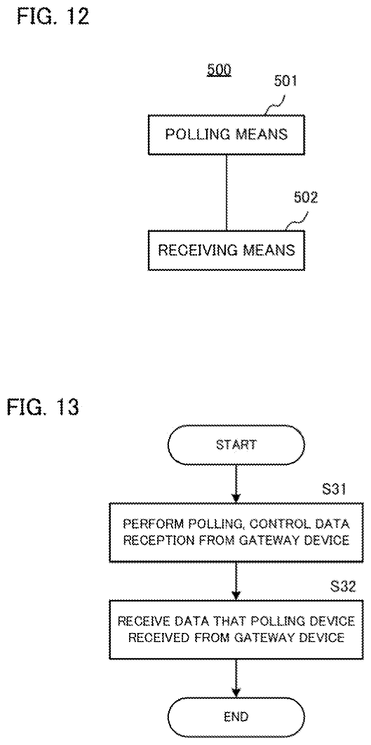

FIG. 12 is a block diagram showing a configuration of a communication device according to a third example embodiment. The communication device 500 comprises a polling means 501 and a receiving means 502.

FIG. 13 is a flowchart of processing by the communication device 500. The polling means 501 performs polling to a gateway device that receives data from a wireless communication terminal to control data reception of the gateway device from the wireless communication terminal, and receives the data that the gateway device received from the wireless communication terminal from the gateway device (step S31). The receiving means 502 receives the data that the polling means received from the gateway device (step S32). Thus, the communication device 500 can collect data from the wireless communication terminal with at least possible delay.

A part or all of the example embodiments described above may also be described as the following supplementary notes, but not limited thereto.

(Supplementary note 1)

A communication system comprising:
a wireless communication terminal configured to transmit acquired data by wireless communication;
a gateway device configured to receive the data from the wireless communication terminal;
a polling device configured to perform polling to the gateway device to control data reception of the gateway device from the wireless communication terminal, and receive the data that the gateway device received from the wireless communication terminal from the gateway device; and
a server device configured to control activation and stop of the polling device, and receive the data that the polling device received from the gateway device.

(Supplementary note 2)

The communication system according to Supplementary note 1, wherein the polling device instructs the gateway device to search for the wireless communication terminal by the polling.

(Supplementary note 3)

The communication system according to Supplementary note 2,
wherein the wireless communication terminal periodically transmits advertising, and
wherein the polling device instructs the search for the wireless communication terminal at a timing set according to the timing at which the wireless communication terminal transmits the advertising.

(Supplementary note 4)

The communication system according to any one of Supplementary notes 1 to 3, wherein the polling device stores the data received from the gateway device in a storage device.

(Supplementary note 5)

The communication system according to Supplementary note 4, wherein the polling device transmits, out of the data received from the gateway device, the data other than the data that elapsed more than a predetermined time to the server device.

(Supplementary note 6)

The communication system according to any one of Supplementary notes 1 to 5, wherein the gateway device acquires the data from the wireless communication terminal when a timing of the advertising by the wireless communication terminal matches a timing of a search by the gateway device.

(Supplementary note 7)

A communication device comprising:
a polling means configured to perform polling to a gateway device that receives data from a wireless communication terminal to control data reception of the gateway device from the wireless communication terminal, and receive the data that the gateway device received from the wireless communication terminal from the gateway device; and
a receiving means configured to receive the data that the polling means received from the gateway device.

(Supplementary note 8)

A communication method comprising:
performing polling to a gateway device that receives data from a wireless communication terminal to control data reception of the gateway device from the wireless communication terminal;
receiving the data that the gateway device received from the wireless communication terminal from the gateway device; and
receiving the data that the polling means received from the gateway device.

(Supplementary note 9)

A recording medium recording a program, the program causing a computer to execute processing of:
performing polling to a gateway device that receives data from a wireless communication terminal to control data reception of the gateway device from the wireless communication terminal;
receiving the data that the gateway device received from the wireless communication terminal from the gateway device; and
receiving the data that the polling means received from the gateway device.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

10 Home terminal
20 Pet terminal
200 Server
210 Polling device
300 User terminal

What is claimed is:

1. A communication system comprising:
a wireless communication terminal configured to transmit acquired data by wireless communication;
a gateway device configured to receive the data from the wireless communication terminal;
a polling device configured to perform polling to the gateway device to control data reception of the gateway device from the wireless communication terminal, and receive the data that the gateway device received from the wireless communication terminal from the gateway device; and
a server device configured to control activation and stop of the polling device, and receive the data that the polling device received from the gateway device.

2. The communication system according to claim 1, wherein the polling device instructs the gateway device to search for the wireless communication terminal by the polling.

3. The communication system according to claim 2,
wherein the wireless communication terminal periodically transmits advertising, and
wherein the polling device instructs the search for the wireless communication terminal at a timing set according to the timing at which the wireless communication terminal transmits the advertising.

4. The communication system according to claim 1, wherein the polling device stores the data received from the gateway device in a storage device.

5. The communication system according to claim 4, wherein the polling device transmits, out of the data received from the gateway device, the data other than the data that elapsed more than a predetermined time to the server device.

6. The communication system according to claim 1, wherein the gateway device acquires the data from the wireless communication terminal when a timing of the advertising by the wireless communication terminal matches a timing of a search by the gateway device.

7. A communication device comprising:
a memory configured to store instructions; and
one or more processors configured to execute the instructions to:
perform polling to a gateway device that receives data from a wireless communication terminal to control data reception of the gateway device from the wireless communication terminals; and
receive the data that the gateway device received from the wireless communication terminal from the gateway device.

8. (canceled)

9. (canceled)
